(19) United States
(12) Patent Application Publication
(10) Pub. No.: US 2015/0085106 A1
(43) Pub. Date: Mar. 26, 2015

(54) Method and apparatus for imaging using mechanical convolution

(71) Applicant: Christopher J. Brittain, San Jose, CA (US)

(72) Inventor: Christopher J. Brittain, San Jose, CA (US)

(21) Appl. No.: 14/204,122

(22) Filed: Mar. 11, 2014

Related U.S. Application Data
(60) Provisional application No. 61/777,278, filed on Mar. 12, 2013.

(51) Int. Cl. G01B 11/02; G06T 5/20

(52) U.S. Cl. CPC G01B 11/02; G06T 5/20
USPC 348/135

(57) ABSTRACT

A method and apparatus for imaging using mechanical convolution is provided. By convolving light emitted from objects laterally with physical blades multiple times at different positions, a computer implemented imaging system can greatly enhance the resolution of the imaged objects. In another variation, convolving the light emitted from objects by a single blade at different positions also allows a computer implements imaging system to enhance the resolution of the imaged objects. In yet another variation, convolving the light emitted from objects by a single blade at an angle will yield information about the flux gradient of the light coming from the objects, and using the same techniques applied above, an imaging system can enhance the resolution of the imaged objects.

This application claims the benefit of U.S. Provisional Application Ser. No. 61/777,278, filed Mar. 12, 2012, which is incorporated herein by reference in its entirety.

### BACKGROUND

As light radiates through space it spreads due to diffraction, a wave effect. This wave effect limits the resolution of the human eye and other electromagnetic imaging devices, such as microscopes and telescopes. In 1873, physicist Ernest Abbe expressed this limit as: d=λ/2(n sin θ), where “d” is the diameter of a resolvable spot, “λ” is the wavelength of light, “n” is the index of refraction of the transmitting medium, and “θ” is the spot angle. This limit was later expressed by astronomer W. R. Dawes in terms of aperture: R=11.6/D, where “R” is the angular separation in arcseconds between two resolvable points, and “D” is the aperture in centimeters of the viewing device.

Since then, astronomers have addressed the diffraction limit by building telescopes with increasingly larger apertures, primary mirrors, and objective lenses. However, as the size of the telescope increases, the costs associated with building and maintaining the telescope skyrocket to prohibitive levels. Using these large powerful telescopes is far out of the reach of amateur astronomers, and even governments struggle with the costs of running large telescopes. Thus, there is a demand in astronomy for a new practical low-cost method for increasing telescope resolving power.

In microscopy, information on relevant attempts to increase resolution can be found in U.S. Pat. No. 5,043,570 and U.S. Pat. No. 5,731,588. However, each one of these references disclose systems that require highly controlled scanning environments, ill-suited for applications where the imaging object is not easily manipulated, such as star systems hundreds of parsecs from Earth. These systems are further limited by their complex controls, unwieldy size, extreme delicacy, slow imaging speed, and high costs associated with building and running the systems. Thus, there is a demand in microscopy for a new practical low-cost method for increasing microscope resolving power.

### DRAWINGS

FIG. 1A-B show an example two-blade variation of the imaging system and method;

FIG. 2A-D show example two-dimensional graph plot results of the imaging system;

FIG. 3 shows an example three-dimensional graph surface result of the imaging system with point maximas indicated;

FIG. 4A-G show example image outputs of the imaging system;

FIG. 5A-B show example two-dimensional graph plot results of a two object system of unequal magnitude;

FIG. 6 shows a three-dimensional false positive graph plot result of a two object system that appears to be of unequal magnitude;

FIG. 7A-B show three-dimensional graph surface results that may be used to determine dimensions by using multiple perspectives;

FIG. 8A-C show graph plot and surface results where multiple perspectives are used to determine object shape and size;

FIG. 9A-C show a variation of the imaging system using a blade at angle;

FIG. 10A-D show example options of blade types and configurations;

FIG. 11A-B show ocular views through an imaging system using different blade configurations;

FIG. 12A-B show different types of filters that may be used with the imaging system;

FIG. 13 shows an example variation of the imaging system using out of focus methods;

FIG. 14 shows an example variation of the imaging system using two illumination devices for imaging objects;

FIG. 15 shows an example variation of the imaging system using different positions in Earth's orbit.

### DESCRIPTION

Here below, modes for caring out mechanical convolution imaging shall be explained with reference to the drawings.

### Summary of the Present Embodiment

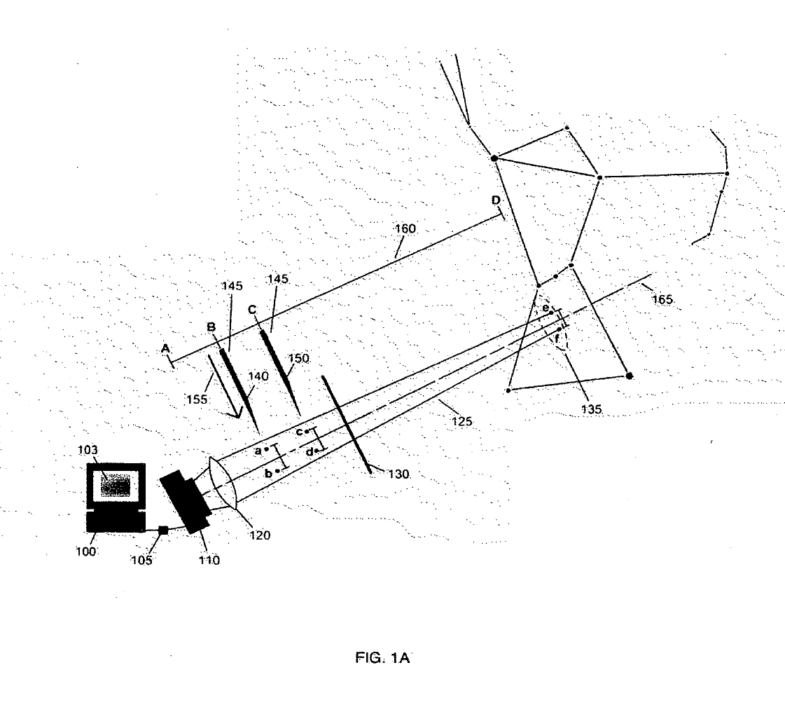

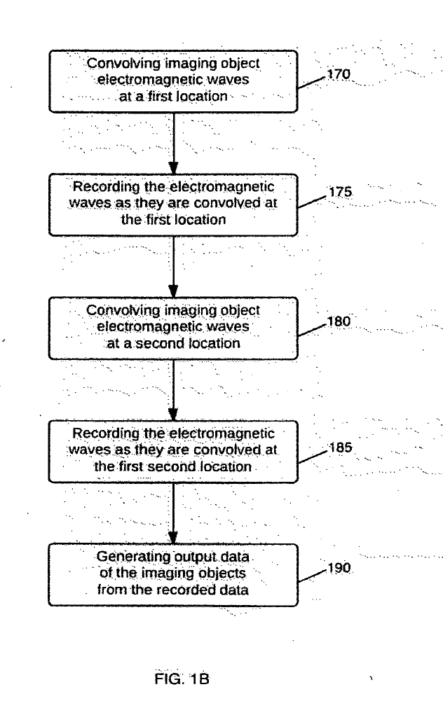

In the present embodiment, a convolving blade is used to distort light waves coming from imaging objects to reveal characteristics about the waves to enable higher resolution imaging of the objects. FIG. 1A is a diagram showing one possible variation of the imaging system. In this variation, the imaging objects [135] are electromagnetic sources, such as stars, that create an electromagnetic or light path [125], that may be convolved by a convolution blade system [145] comprising one or more blades [140, 150] and an optional labeling filter [130]. As the imaging objects [135] are imaged through a lensing system [120] by a sensor [110], such as a CCD/CMOS image sensor, lux meter, or phototransistor, one of the blades in the system, the first blade [140] for example, is inserted into the light path [125] to create recorded wave data [105] which is a recording of the light path as it is changed by the blade insertion. The recorded wave data [105] is then sent to a computer system [100] for processing to generate useful output data [103] about the imaging objects [135].

In FIG. 1A, the imaging objects [135] are denoted by point maximas e and f, which are at a distance AD from the sensor [110], where two points side-by-side (“AD”) represent the distance between them, as shown on the reference line [160]. Point maximas can be thought of as point spread function local maximas of radiating objects. Point maximas e and f spread out on the path from A to D. At point C on the reference line [160], e and f point maximas are represented by points c and d, respectively. At point B on reference line [160], the same point maximas are represented by a and b. Thus, the distance between the point maximas increases as the light travels from the imaging objects [135] to the sensor [110], such that of <cd<ab.

The light path [125] defines the boundary of light or electromagnetic waves radiating from the imaging objects [135]. The light path [125] may be labeled using an optional labeling filter [130] such as a polarizer or color filter, as explained below. The convolving blade system [145] in this variation may consist of materials that have characteristics opposite that of the labeling filter [130] which may also be considered part of the convolving blade system [145]. If the labeling filter [130] consists of a vertically aligned polarizer, then the blades [140, 150] may consist of horizontally aligned polarizers. Similarly, if the labeling filter [130] is a green light frequency pass filter, then the blades [140, 145] may consist of filters that are notched to filter out green light. If the labeling filter [130] is omitted from the convolving blade system [145], then the blades [140, 150] may consist of opaque or translucent materials, such as steel razor blades or liquid crystals. Alternatively, the convolving blade system [145] may consist of a single first blade [140] with or without the labeling filter [130], inserted once to create one result, inserted at an angle to create a flux gradient result, or inserted at different places in the light path [125]. The blades [140, 150] in this variation are designed to move on an axis [155] that is perpendicular to the light path axis [165] in discrete or continuous movements. The blades [140, 150] may be actuated using linear actuators or equivalent means of movement known in the art.

A simplified example method using this system is shown in FIG. 1B. At the first step [170], the first blade [140] is inserted into the light path [125] in the direction of the reference arrow axis [155] at a first position B. As the blade travels farther into the light path, it cuts off more light in the path thus changing the signal received by the sensor [110]. At the second step [175], the sensor [110] records this movement of the blade through the light path and sends it as recorded wave data [105] to the computer system [100], after which the first blade is removed. At the third step [180], the second convolving blade [150] is inserted into the light path [125] in the direction of the reference arrow axis [155] at a second position C. As the second blade [150] travels farther into the light path, it cuts off more light in the path thus changing the signal received by the sensor [110]. At the fourth step [185], the sensor [110] records the second blade's movement through the light path and sends it as a second set of recorded wave data [105] to the computer system [100], after which the second blade is removed. Next at the fifth step [190], the computer system [100] uses the first and second set of recorded wave data to generate output data [103] regarding the imaging objects, such as their range, shape, size, plots, surfaces, or images. Another equal variation includes starting the convolving steps [170, 180] with the blades fully inserted and measuring the light path [125] with the sensor [110] as the blades are removed. Another variation includes having only one convolving step [170] where the blade is inserted perpendicular to the light path [125] or at an angle, and one recording step [180] then immediately starting the fifth step [190].

The following is another example of how this variation works referring to FIG. 1A, though one skilled in the art will appreciate that the ordering can again be changed and elements modified. The sensor [110] is directed towards the imaging objects [135] to record the incoming light path [125]. The light path [125] from the imaging objects [135] is convolved by filtering through the labeling filter [130], which here is a horizontally aligned polarizer. Then, the first blade [140] at point B, here comprised of a vertical polarizer, is moved along an axis [155] so it blocks the now horizontally polarized light incident on the blade. The first blade [140] continues its movement along the axis [155] until it is fully blocking the light path [125]. The first blade's movement through the light path [125] creates a signal representing a convolution of the light path as convolved by the first blade [140]. The sensor [110] records the incoming light path as it is convolved and sends this as recorded wave data [105], which may be a plurality images or a video stream, to computer system [100] for processing. Next, the process may be repeated with the second blade [150] at point C. The computer system [100] may then use the recorded wave data [105] to output object dimension data such as size, shape, and range to the imaging objects [135] as output data [103]. Alternatively the computer system [100] may use the recorded wave data [105] to enhance pre-recorded images (images of the light path un-convolved by the blades) of the imaging objects [135] through image processing and output that as output data [103]. Alternatively the computer system [100] may use the recorded wave data [105] to generate entirely new computer graphic representations of the imaging objects [135] as the output data [103].

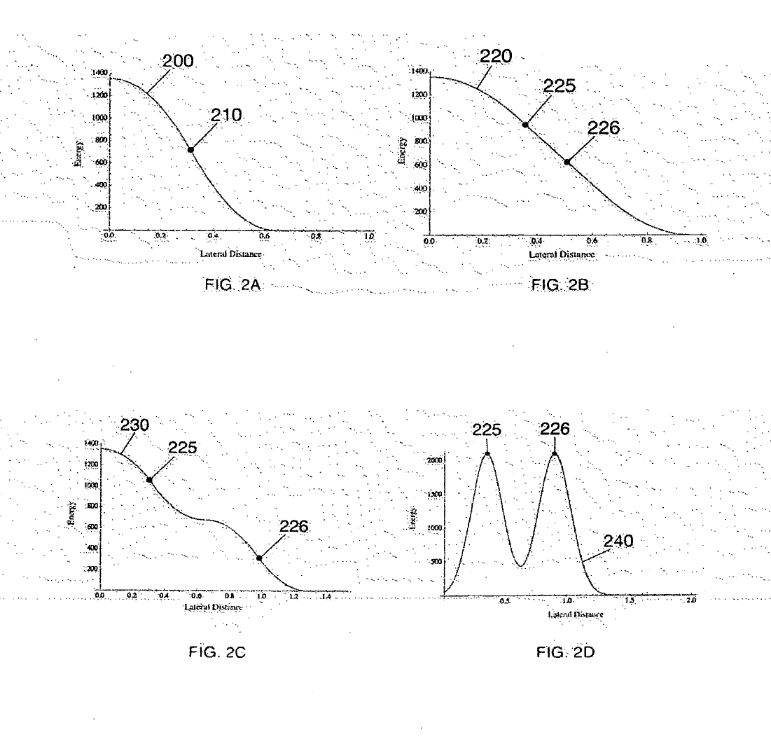

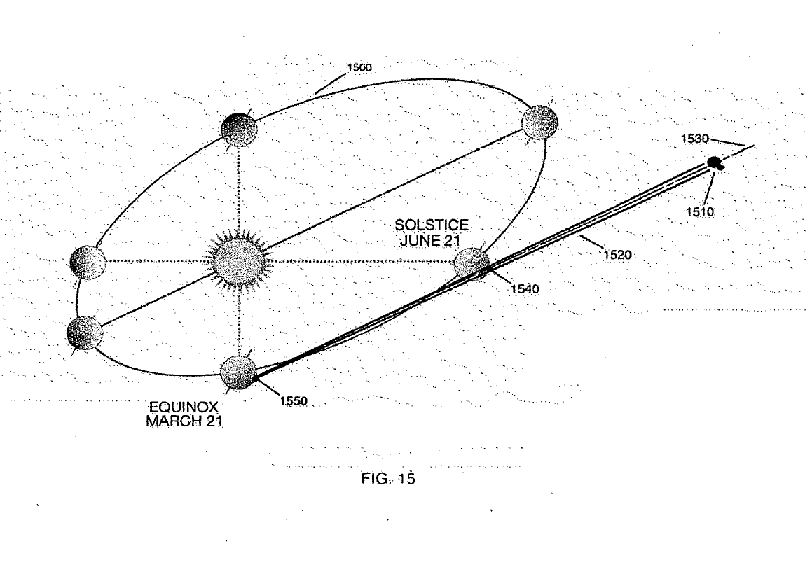

FIG. 2A-D show possible sensor outputs of convolved light path data. FIG. 2A shows a graph plot [200] where the distance AD between the sensor [110] and the imaging objects [135] is greater than the distance set by the diffraction limit. In this situation, point maxima's e and f are essentially indistinguishable from one another and lie at the center point [210] of the graph plot [200]. Note, however that this graph would be virtually identical to a graph plot of a single point maxima system of just e for example, where f is non-existent. Thus an observer (not depicted) using the imaging sensor [110] at this great a distance would have a difficult time determining whether there are two point maximas, e and f, or just one, e. FIG. 2B shows a graph plot [220], where the light path [125] has been convolved by the first convolution blade [140] at a distance of AB from the sensor [110]. Due to diffractive spreading, where ab>ef, point maximas a and b are further spread out on the graph plot [220], and lie at an approximate first point [225] and second point [226], respectively. FIG. 2C shows a graph plot [230], where the light path [125] is convolved by a second convolution blade [150] at a distance AC from the sensor. Due to diffractive spreading, where ab>cd, point maximas c and d are more spread out on the result slope plot [230] than their a and b counterparts, and lie at an approximate first point [225] and second point [226] as shown on graph plot [230], respectively. Further, as the distance of AC approaches that of AD (i.e., AC→AD), point maximas c and d grow further apart if magnified properly, thereby allowing more accurate measurements of the imaging objects [135] to be made. For example, if the imaging objects [135] consist of a far away binary star system where AD is many parsecs long, the second blade [150] at AC should appropriately be as far from the sensor [110] as possible to capture as much diffractive spreading of the light path [125] as possible. Other types of far-away blades are disclosed in FIG. 11B and FIG. 15 and are discussed below.

One advantage of the imaging system disclosed is that using a blade to convolve a light path is a highly versatile way of increasing resolution. Whereas telescopes may increase resolution by increasing apertures “horizontally”, the system disclosed here increases the resolution “vertically”, positioning the blade nearer and nearer to the imaging objects, convolving them one or more times to yield useful data. Another advantage of the blade system disclosed here is that it is far easier to use than a scanning system because with the system here, the imaging objects are imaged all at once, instead of scanning them little by little which is not possible in many imaging applications. Yet another advantage of the imaging system disclosed is it may be built and customized using off the shelf parts and computer software which can keep costs very low compared to the prior art.

Analytically, the plots in FIG. 2A-C may be represented mathematically as, ΔB, of the convolution integral where:

ΔB=ƒ(τ)*g(x)=∫_{-∞}^{∞}ƒ(τ)(x−τ)dτ 1-1

In equation 1-1, the function ƒ may represent the convolution blade system [145]. One possible function that may mathematically represent ƒ is a negative variation of the Heaviside step function wherein the Dirac delta function, δ(s), is integrated over ds, but where the limits, x and ∞, are reversed to produce a negative step-function. See equation 1-2 for ƒ in general form.

ƒ=∫ₓ^{∞}δ(s)ds 1-2

In equation 1-1, the function g may represent the imaging objects [135]. One possible function that may represent g is a superposition of two Gaussian point spread functions as shown in equation 1-3, and approximated in FIG. 2D. In this equation, A and B are amplitude normalization variables; α and β, are diffraction spread normalization variables; and η is the shift variable that shifts the second point spread function laterally. Further, Ae^{-αx}^{²} can be thought to correspond to a point spread function of one of the imaging objects [135] with a point maxima e at its peak, and Be^{-β(x±η)}^{²} can be thought to correspond to the point spread function of the other of the imaging objects [135] with a point maxima f at its peak, but shifted laterally by η. In some applications, where there is a lack of information about the point spread functions, simple discrete functions such as unit triangles may be used to represent the point spread functions. Computer system [100] can model the graph plots [200, 220, 230] of the imaging objects [135] by applying curve fitting techniques as are known in the art, wherein A, B, α, β, and η are adjusted to allow the convolution integral, AB, to best fit recorded wave data [105]. In particular, a person of ordinary skill in the art can readily apply these techniques using software with imaging modules, such as MATLAB and Mathematica, using linear regression or similar techniques, but may also apply the above methods using custom coded imaging software as well.

g(x)=Ae^{-αx}^{²}±Be^{-β(x±η)}^{²} 1-3

FIG. 2D shows a deconvolution graph plot [240] produced from result slope [230] through methods described here. On the deconvolution graph plot [240], point maximas a and b now lie at the first point [225] and the second point [226] which coincide with the local maximas of plot [240]. The deconvolution plot may be generated by taking the derivative of AB with respect to the lateral distance x. The deconvolution plot is not limited to representation by derivatives of AB. Other methods known in the art may be applied such as dividing the Laplacian Transform of ΔB by the Laplacian Transform of ƒ or g and taking the Inverse Laplacian Transform of the quotient, as shown in equation 1-4, where [symbol] is an intermediary dimension.

$$g ( x ) = ( \frac{{ℒ}_{τ} ( Δ B ) ( )}{{ℒ}_{τ} ( f ) ( )} ) ( x ) \qquad 1 \text{-} 4$$

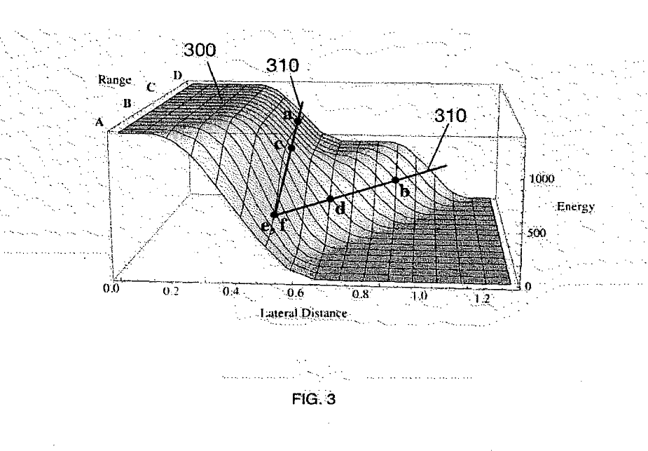

FIG. 3 shows a three dimensional surface [300], two of space (“Range” and “Lateral Distance”) and one of energy (“Energy”), of the convolution produced by a blade, such as the first blade [140], and the light path [125] at a plurality of ranges denoted by points A, B, C, D. Light point maximas e and f, c and d, and a and b are also labeled on surface [300] along point maxima axes [310]. The convolution surface [300] may be used in correlation with the techniques described above (as shown in FIG. 2A-D) to give the complete energy-space dimensions of electromagnetic radiation from the imaging objects [135]. In particular, the actual distance between points e and f may be found using the point maxima proportion equation 1-5, and the range from the sensor [110] to the imaging objects [135], AD, may be found using the point maxima equation 1-6.

ef=cd²/ab 1-5

AD=AB+BC+BC(cd−ef/ab−cd) 1-6

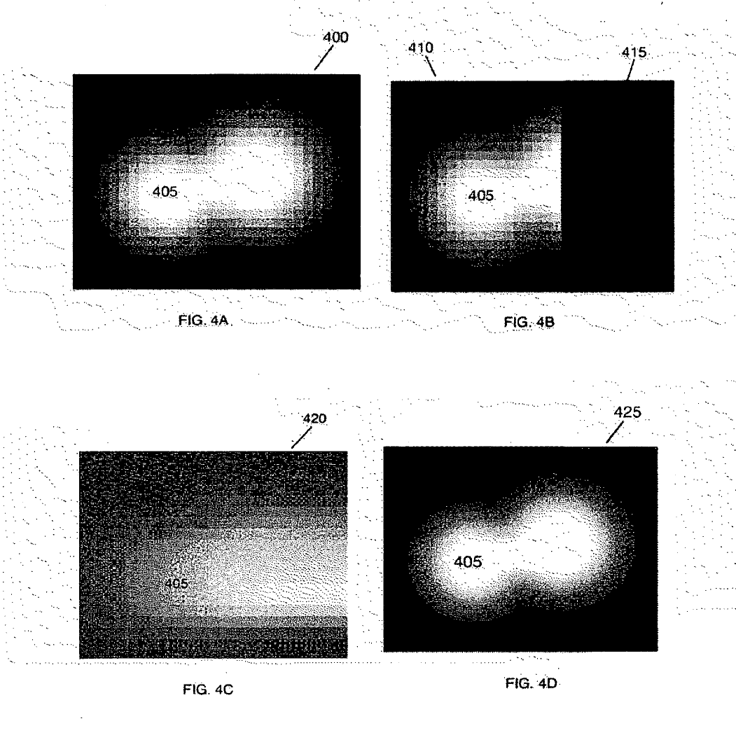

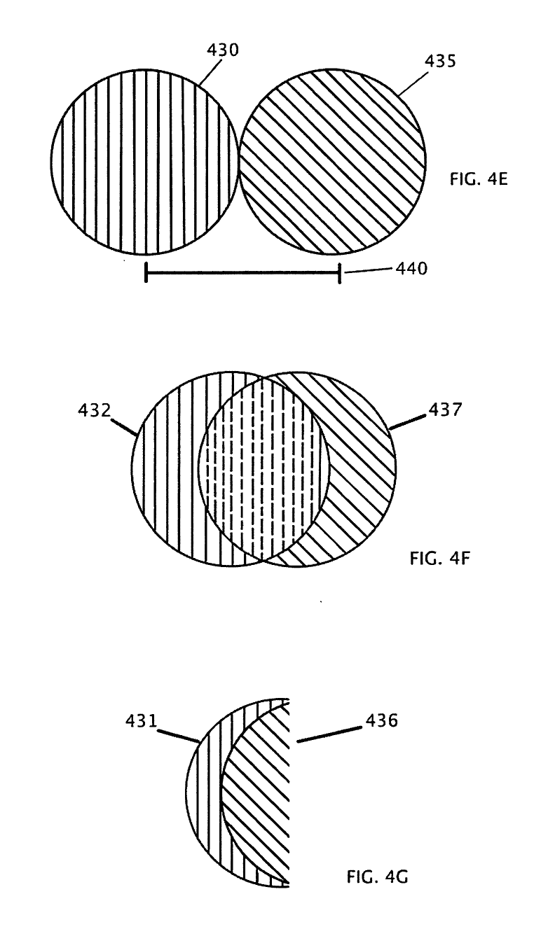

The principles that create the two-dimensional graph plots of FIG. 2A-D, which use one dimension of energy (“Energy”) and one of space (“Lateral Distance”) may similarly be extended to two-dimensional plots using two dimensions of space, also known as images, as shown in FIG. 4A-G. The image shown FIG. 4A is an example image or video stream capture [400] from a CCD camera imaging a two-object system [405]. FIG. 4B shows an image or video stream capture [410] of the two-object system [405] as it is convolved from right to left with a blade [415], which is denoted by black pixels of value 0. Using the computing system [100], the recorded wave data [105] of images or a video stream may undergo image processing, such as image stacking, or matrix operations as are known in the art to create the convolved image output [420] with the two-object system [405] now convolved with a blade [140], as shown in FIG. 4C. The process may be repeated with a second blade [150] at different range, CD, to the two body system [405] to yield a second convolved image output (not shown), thereby allowing a determination of the two-object system's dimensions as using the above disclosed techniques, which in image and video processing are analogous to motion estimation vectors, to yield a higher resolution image [425] as shown in FIG. 4D.

While the images in FIG. 4A-D, are grayscale with pixel values between 1 (white) and 0 (black), FIG. 4E-G show how the same principles may be applied for color images with channel RGB data. In FIG. 4E a green light spot [430] and a red light spot [435] have point light maximal (here spot centers) that are 28 microns apart as indicated by a reference line [440]. At great distances, such as AD, the two spots [430, 435] mix together due to wave diffraction and interference, as shown in FIG. 4F. Using the convolution blade processes described above, an image sensor will receive the output shown in FIG. 4G, where color the channel data green is highly prevalent on the left side the convolved spot [431] in a bowed arc which follows the perimeter of the diffracted green spot [432] and color channel data red is highly prevalent on the right side of the convolved spot [436] in a bowed arc, which again follows the perimeter of the diffracted red spot [437]. A person of ordinary skill in the art may then use trigonometry and geometry methods to find the center points of the red and green spots using the bowed arcs.

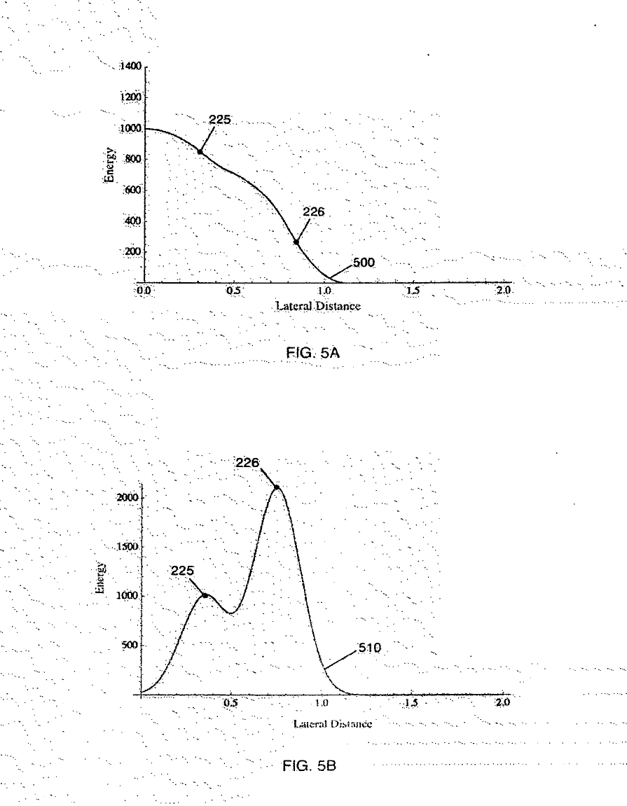

FIG. 5A-B show possible result graphs where one point maxima, for example e, is of a smaller energy magnitude than point maxima f. FIG. 5A shows a result of the convolution process in a graph plot [500] with a reduced plot slope around e at the first point [225], whereas there is a larger slope around fat the second point [226]. A deconvolution result slope [510] in FIG. 5B more readily shows the nature of the system. Point maxima e, at the first point [225], lies at a smaller local maxima than point maxima f, which lies at the second point [226] at a larger local maxima. This indicates that point maxima f comes from a higher or closer energy source, such as a brighter or nearer star.

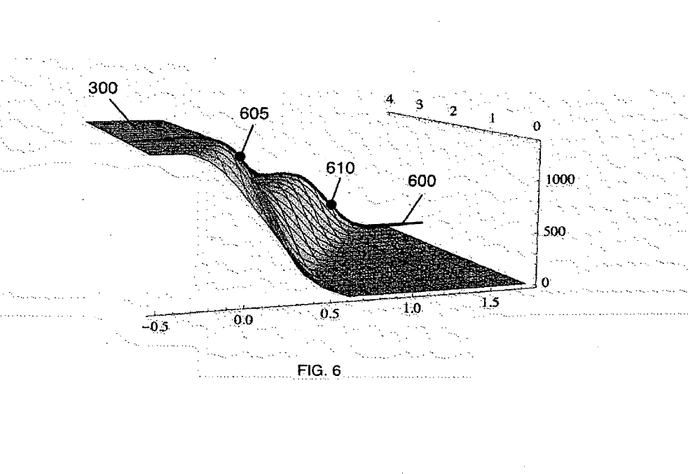

FIG. 6 shows a three-dimensional surface [300] of FIG. 3, but from a different perspective, that allows the computer system [100] to avoid perspective errors. From this perspective, perspective plot [600] corresponds to a convolution blade movement (not shown) through the surface [300]. The plot [600] appears to have a smaller magnitude point maxima [605] near a larger magnitude point maxima [610], which may cause the computer system [100] to conclude that the apparent smaller point maxima [605] was generated from a dimmer or farther energy source and the larger point maxima [610] was generated by a brighter or closer energy source, but this it is not the case. Rather, the smaller point maxima [605] is due to a perspective skew. In reality, the graph surface [300] was generated by the two point maximas of the same energy magnitude and range.

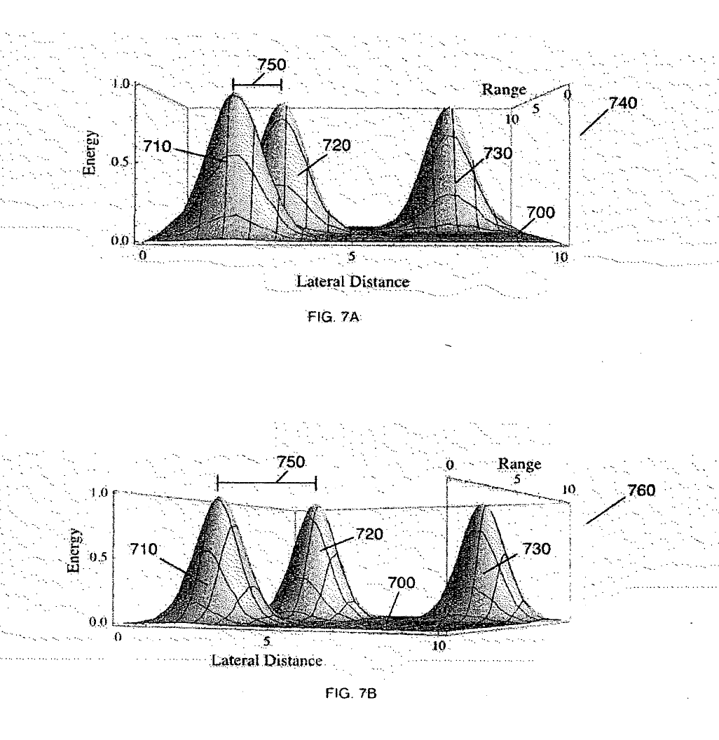

FIG. 7A-B show a surface [700] where perspective may be used by the computer system [100] to determine ranges. FIG. 7A shows a first point spread function [710] at a range of 2, a second point spread function [720] at a range of 6, and a third point spread function [730] at a range of 8, all viewed from a first perspective [740] where it is not readily apparent which of the point spread functions is closer or farther in the absence of the shading and numbered graph axes. A reference distance [750] between the peak maximas of the first and second point spread functions [710, 720] provides a measurable data value which can be found using the above described convolution techniques. Viewed from a different perspective [760] in FIG. 7B, where a shift has occurred, the reference distance [750] between the two point maximas is now demonstrably larger, thus allowing ranges to the point spread functions [710, 720] to be more readily determined. A method exemplifying this processes would be to first convolve spots [710] and [720] from the first perspective [740] to record the convolution curves shown in FIG. 2A-D, for example, and measure the distances between the maximas [750], then move the imaging system laterally to the second perspective [760] and repeat the process of recording the distance between point maximas [750], thereby revealing that the first point maxima [710] is at a closer range of 2, than the second point maxima [720] with range 6.

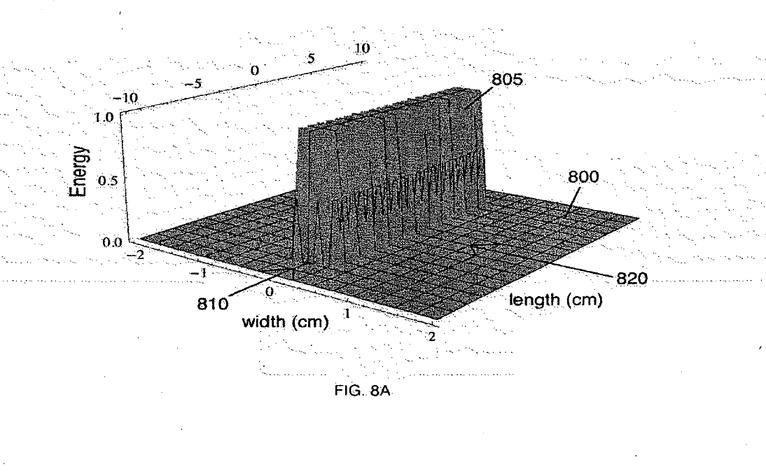

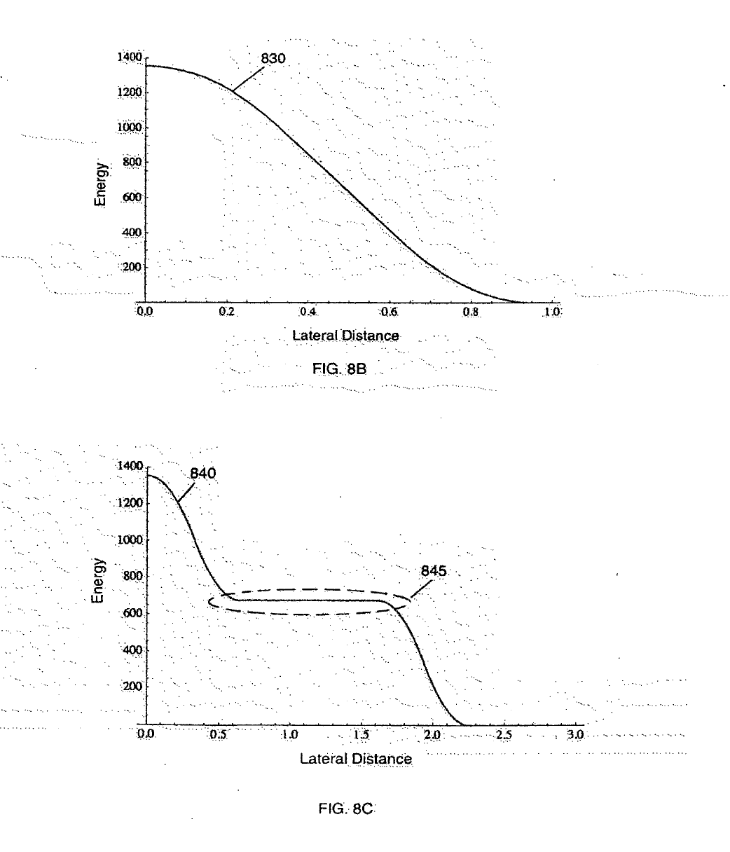

FIG. 8A-C show a similar technique using perspective to find object shapes. In FIG. 8A, a surface [800] represents a point spread function of an object [805] with an elongated form. Convolving the object using the techniques disclosed from its narrow face as indicated by a reference arrow [810], will yield a convolution graph plot [830] shown in FIG. 8B. While convolving from its wide face as indicated by reference arrow [820] will yield a convolution graph plot [840] shown in FIG. 8C, where length face point maxima [840] is a plateau which indicates that the object [805] is longer than it is wider. The computer system [100] can then use the plots [830, 840] to recreate a more accurate image of the object [805] using the techniques disclosed above.

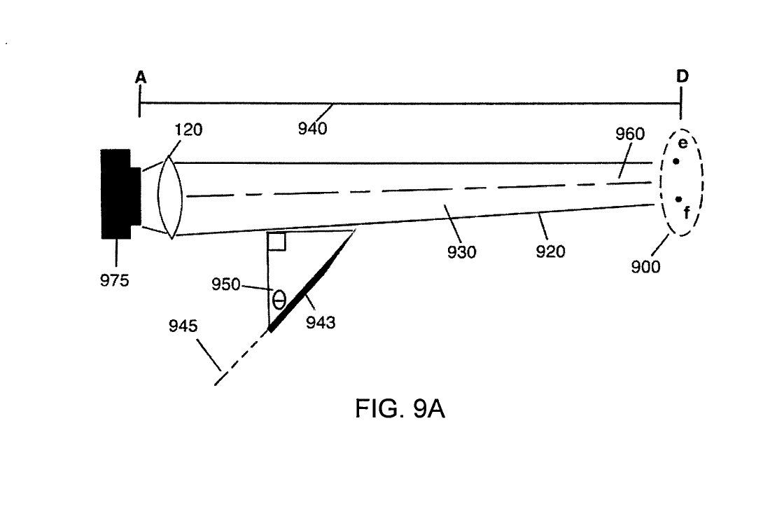

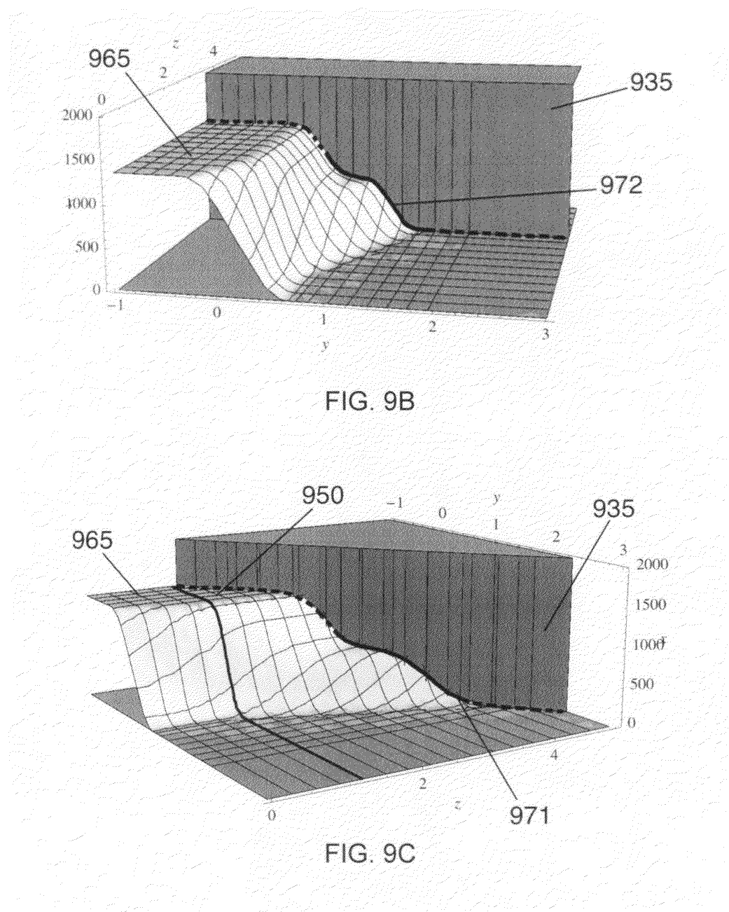

FIG. 9A-C show another possible variation of the imaging system and possible convolution surface outputs. In FIG. 9A, imaging objects [900], represented by e and f, create an electromagnetic or light path [920] that has a flux gradient [930] that decreases in intensity as D→A, which are points on the reference line [940]. In this variation, the convolution blade [943] is inserted along an axis [945] at an insertion angle θ [950] to the light path axis [960]. FIG. 9B shows an example surface output [965] where the blade [935] (here represented by a vertical plane) is at an insertion angle of 0 degrees (degrees not diagrammed). FIG. 9C shows an example surface output [965] where the convolution blade [935] is at an insertion angle [950] of 45 degrees. FIG. 9C shows the effect that changing the convolution blade angle θ [950] has on the data recorded by the sensor [975]. Particularly, the cross-section of FIG. 9C features an elongated lower cross-section slope [971] that will have a different rate of change (i.e. different first and second derivatives) than the cross section slope [972] in FIG. 9B. By using a single blade at an angle, the imaging system is able to forgo taking multiple measurements at different positions along the light path, and instead take one measurement at an angle where the convolution of the flux gradient discloses how the light path [125] evolves as D→A. However, even at an angle of 0 degrees (perpendicular) convolving the light path data may still yield more information than imaging the imaging objects without any blade processes.

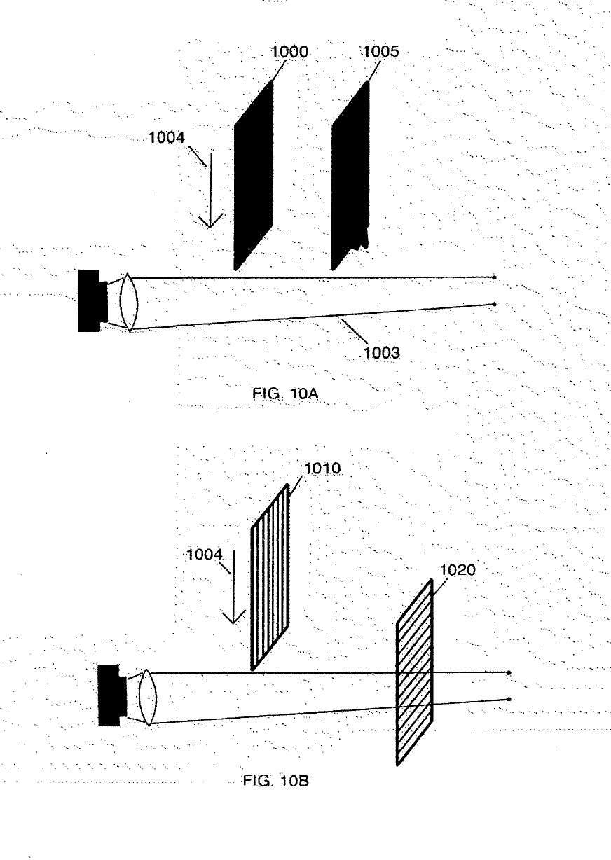

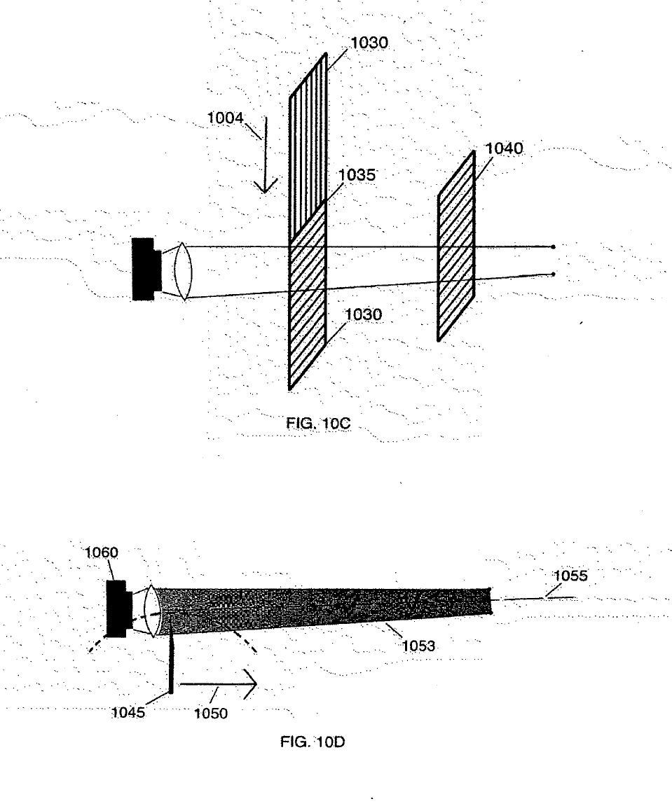

FIG. 10A-D show different configurations and types of convolution blades that may be used with the imaging system. In FIG. 10A, a steel razor blade with a straight edge [1000] is inserted into the light path [1003] in the direction of a reference arrow [1004]. Due to steel's opaque nature, no labeling filter [130] (as shown in FIG. 1) is required. Alternatively, a steel razor blade with partially jagged edge [1005] may be used to customize the convolution output, such that the jagged edge convolves the light path before the straight edge does, acting as a specialized spatial filter. Another variation utilizes polarizers as shown in FIG. 10B. There, a convolution blade [1010] is a vertically aligned polarizer and a labeling filter [1020] is a horizontally aligned polarizer. An advantage of using polarizer blades is that they cause less “smear” of the light as it is convolved.

FIG. 10C shows another variation wherein the convolution blade consists of two orthogonal polarizers [1030] joined along an adjacent edge [1035], where the labeling filter [1040] consists of a polarizer parallel to one of the polarizers used in orthogonal blade [1030]. FIG. 10D shows a variation of the imaging system wherein the blade [1045] is held tangent to the light path axis [1055]. Using this configuration, single images or multiple images combined using image stacking will yield better resolution than had no blade [1045] been inserted. Alternatively, the blade [1045] held at the tangent of [1055] may undergo a range convolution by allowing the sensor [1060] to record the light path data as the blade [1045] is moved along the direction indicated by the reference arrow [1050].

FIG. 11A shows an ocular view of another convolution blade variation. The blade [1100] is mounted on an aperture [1110] of a lensing system (ocular view) such as a telescope, and remains stationary with respect to the aperture [1110]. A plurality of stars [1120], visible through the un-obstructed portion of the aperture [1105], is then allowed to move the towards the blade [1100] in an apparent motion indicated by the reference arrow [1130] due to Earth's rotation around its axis. Alternatively, if a telescope is utilized, the apparent motion of the stars may be caused by movement of the telescope's tripod motors moving the aperture [1110] into the plurality of stars [1120]. Similarly, large objects such a cliffs, asteroids, or a school tower [1140] may be used to convolve the plurality of stars [1120], as shown in FIG. 11B. Using the school tower [1140], or other far object, as a convolution blade [140] (in FIG. 1) allows an observer to create a larger distance between the sensor [110] and the blade [150] thereby allowing more accurate measurements to be recorded.

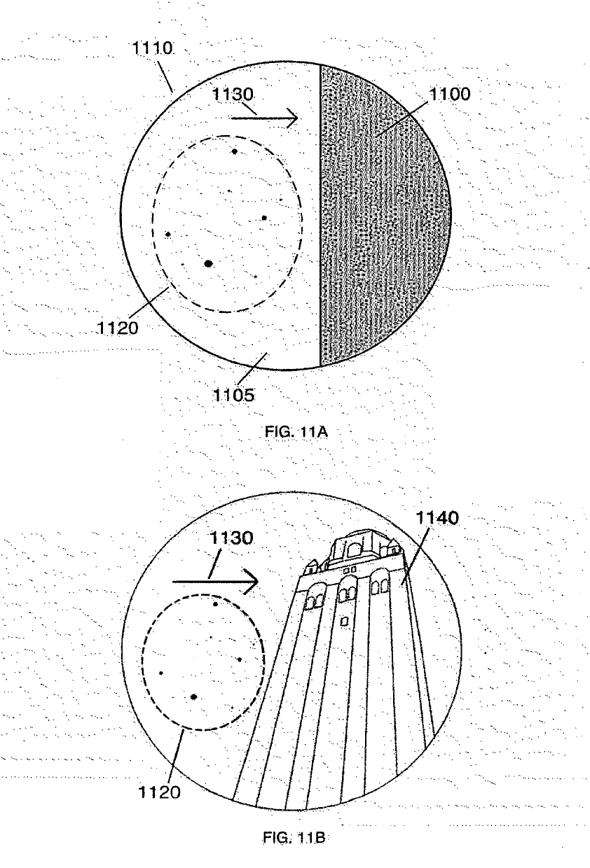

FIG. 12A-B show a variety of optional filtering techniques. To improve the signal to noise ratio (SNR) of the imaging target [1215], such as the stars in Orion's belt, a variety of spatial filters [1250] may be applied to block out signal from noisy nearby objects, such as the moon [1230], as demonstrated in FIG. 12A. Similarly, the light coming from the imaging objects [135] (in FIG. 1) may consist of particular frequencies [1240], as shown in FIG. 12B, which is a frequency/amplitude graph of a notch filter. In this case, a notch filter (not pictured) is devised to block out unwanted noise [1250]. A person of ordinary skill in the art can similarly apply other filters, such as light color filters, polarizers high-frequency pass, and low-frequency pass filters generally.

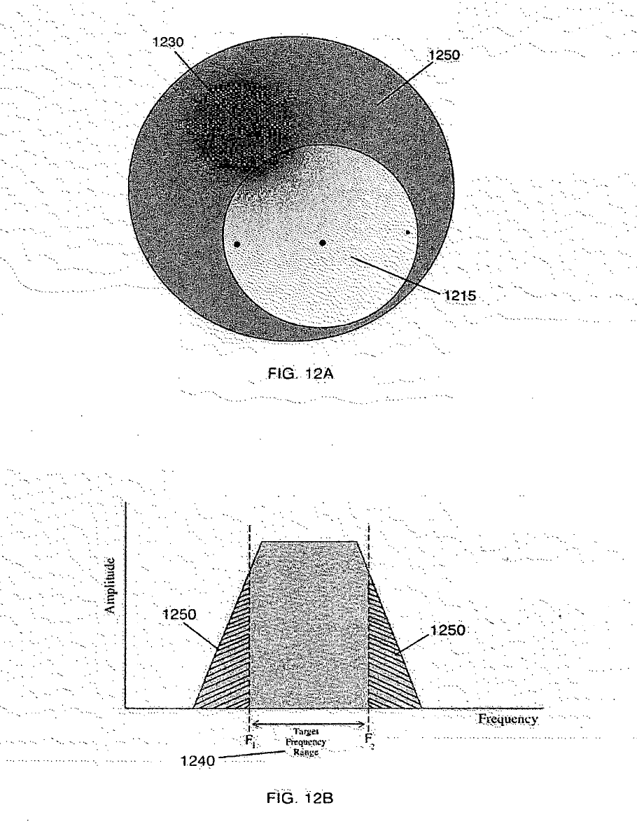

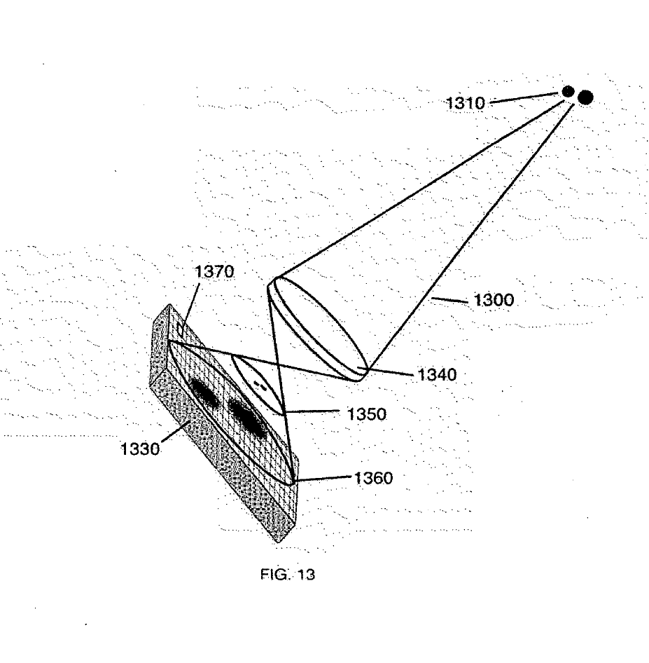

FIG. 13 shows a method for increasing signal energy received by a sensor, such as an image sensor [1330]. Often, the light path or signal energy [1300] coming from the imaging objects [1310] is highly attenuated by the time it reaches sensor [1330]. To improve the signal amplitude and definition, a lensing system [1340] may direct an out-of-focus image plane [1360] on the image sensor [1330], instead of using an in-focus image plane [1350], because the out of focus image plane [1360] causes more sensor elements [1370] to receive signal energy. Similarly, the image sensor [1330] could be replaced by a lux meter with a single recording element, and the lensing system [1340] may focus all of the light path [1300] on the single lux meter element.

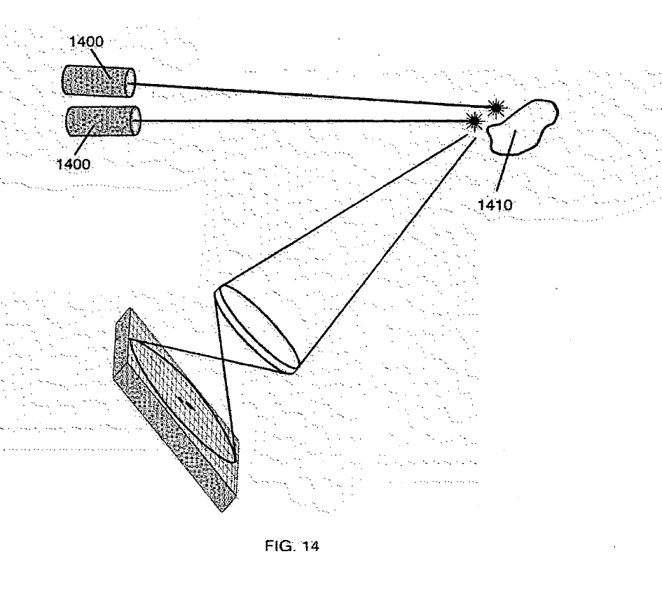

FIG. 14 shows a variation of the imaging system wherein a plurality of light sources [1400] are used to illuminate a target object [1410]. In this variation, the light sources [1400] may be lasers, arc lamps, or other sources of illumination. The advantage of this variation is the ability to determine dimensions, such as range, of an object with no defined features or very low SNR.

FIG. 15 shows a variation of the imaging system using Earth's orbit [1500]. The imaging objects [1510] are on an imaging axis [1530] that intersects Earth's solstice position on June 21 at a solstice position point [1540] and Earth's equinox position on March 21 at an equinox position point [1550]. At the equinox position [1550], a sensor [110], lensing system [120] and a convolving blade system [145], as shown in FIG. 1, take a measurement of a blade [140] as it moves through the light path [1520] at an angle perpendicular to the imaging axis [1530], or at an angle θ therefrom. Later, at the solstice position [1540], the process is repeated. It is noted that the same blade [140] may be used in both processes, first at the equinox position [1550] and second at the solstice position [1540] whereby the second blade [150] is simulated by the first blade [140] at a different position.

After the equinox and solstice processes have been recorded producing two sets of recorded wave data [105], a computer system [100] may generate the plots and images shown in FIG. 2A-D, FIG. 3, and FIG. 4A-G using the techniques disclosed above. A person of ordinary skill in the art that will appreciate that possible variations of this system include using imaging objects that are not aligned with the equinox and solstice positions [1550, 1540] or are out of the plane of Earth's orbit [1500] and using trigonometry to calculate proper distances; or another variation comprising generating plots and images immediately after the equinox position measurement and foregoing the solstice position measurement. The latter method, whereby a second blade measurement is not applied, is of interest because one of ordinary skill in the art can appreciate that even a single convolution blade [140] measurement will reveal higher resolution than if no blade had been applied.

What is claimed is:

1. A computer implemented method for determining dimensions of one or more imaging objects, comprising:
convolving electromagnetic waves from one or more imaging objects at a first location with a convolving blade system;
recording the electromagnetic waves as they are convolved at the first location with a sensor to create a first set of recorded wave data;
convolving the electromagnetic waves from the one or more imaging objects at a second location different than the first location with the convolving blade system;
recording the electromagnetic waves as they are convolved at the second location with the sensor to generate a second set of recorded wave data;
generating output data representative of the one or more imaging objects from the first set and second set of recorded wave data using a computer system.

2. The method of claim 1, wherein the electromagnetic waves are recorded with an imaging sensor.

3. The method of claim 2, wherein a lensing system is used to direct the electromagnetic waves onto the imaging sensor.

4. The method of claim 1, wherein the convolving blade system consists of one or more of blades.

5. The method of claim 4, wherein at least one of the blades includes a filter that transmits at least a portion of incident electromagnetic waves.

6. The method of claim 5, wherein two or more blades of opposite transmission characteristics are used.

7. The method of claim 1, wherein the output data is generated using the convolution integral of a mathematical representation of the blade with a mathematical representation of the one or more electromagnetic sources.

8. The method of claim 1, wherein the output data is generated using point maxima proportions, derivatives, or integral transforms on recorded wave data.

9. The method of claim 1, wherein the output data representative of the one or more electromagnetic wave sources comprises range distance values to the one or more electromagnetic sources or distance values between the one or more electromagnetic wave sources.

10. The method of claim 1 wherein the output data representative of the one or more electromagnetic wave sources comprises graph plots, graph surfaces, or images of the one of more electromagnetic wave sources.

11. An imaging system for determining dimensions of one or more electromagnetic wave sources, comprising:
a sensor positioned to receive electromagnetic waves travelling down an electromagnetic path from imaging objects, that creates recorded wave data;
a lensing system in the electromagnetic wave path between the sensor and the imaging objects that directs the electromagnetic waves onto the sensor;
a convolving blade system positioned alongside the electromagnetic wave path, with blades that can be inserted into the wave path at an angle θ;
and a computer system that is interfaced to the sensor;
whereby the computer system receives recorded wave data from the sensor as the convolving blade system is inserted into the electromagnetic wave path at a first position and a second position, and generates output data representative of the one or more imaging objects.

12. The imaging system of claim 11, wherein the electromagnetic waves are recorded with an image sensor.

14. The imaging system of claim 11, wherein the convolving blade system consists of one or more of blades.

15. The imaging system of claim 14, wherein at least one of the blades includes a transmission filter that passes at least a portion of incident electromagnetic waves.

16. The imaging system of claim 15, wherein two or more blades of opposite transmission characteristics are used.

17. The imaging system of claim 1, wherein the computer system generates the output data by using the convolution integral of a mathematical representation of the blade with a mathematical representation of the one or more electromagnetic sources.

18. The imaging system of claim 1, wherein the computer system generates the output data by using point maxima proportions, derivatives or integral transforms on recorded wave data.

19. The imaging system of claim 1, wherein the output data representative of the one or more electromagnetic wave sources comprises range distance values to the one or more electromagnetic sources or distance values between the one or more electromagnetic sources.

20. The imaging system of claim 1 wherein the output data representative of the one or more electromagnetic wave sources comprises graph plots, graph surfaces, or images of the one of more electromagnetic wave sources.
